(19) United States
(12) Patent Application Publication
(10) Pub. No.: US 2012/0006302 A1
(43) Pub. Date: Jan. 12, 2012

(54) METHOD FOR CONTROLLING THE PRESSURE IN A HIGH-PRESSURE FUEL RESERVOIR OF AN INTERNAL COMBUSTION ENGINE

(76) Inventors: Marc Merigault, Stuttgart (DE); Geraud Devos, Stuttgart (DE)

(21) Appl. No.: 13/116,189

(22) Filed: May 26, 2011

(30) Foreign Application Priority Data
Jul. 6, 2010 (DE) 102010031002.6

(51) Int. Cl. F02M 37/04

(52) U.S. Cl. 123/495

(57) ABSTRACT

A method for controlling the pressure in a high-pressure fuel reservoir of an internal combustion engine; fuel from a presupply pump being supplied to a quantity control valve; and the fuel metered by the quantity control valve being transported by a high-pressure pump into the high-pressure fuel reservoir; the pressure in the high-pressure fuel reservoir being controlled by controlling the quantity control valve; and the supply pressure in front of the high-pressure pump also being considered in the control.

### BACKGROUND INFORMATION

Even though the present invention is hereinafter described principally with regard to common rail systems (CRS), it is directed to pressure control in all types of high-pressure fuel reservoirs.

Nowadays, common rail systems are widely used for fuel injection in diesel engines. Modern common rail systems are often equipped with a so-called dual-actuator rail pressure controller. In such a system, the rail pressure is adjusted either by throttling the high-pressure pump via a valve (metering unit (MeUn)) situated in front of the high-pressure pump, or by a valve situated on the high-pressure side (pressure control valve (PCV)). Therefore, in principle, the rail pressure control in such a system may be operated using three different operating modes (MeUn, PCV and mixed operation). In diesel vehicles, this is used, in particular, in order to, e.g., on one hand, introduce heat into the fuel system immediately after a cold start in winter (PCV operation at a high power loss) and consequently minimize the risk of gelling, and in order to, on the other hand, minimize the power loss during warm operation by compressing only the mass of fuel that is actually necessary (MeUn operation).

However, in the case of certain structural embodiments, it has been shown that the rail pressure control does not function optimally in MeUn operation.

Therefore, it is desirable to improve the quality of the rail pressure control in MeUn operation.

### SUMMARY OF THE INVENTION

In the case of controlling pressure via the amount of fuel delivered (e.g., MeUn operation), a driving current for a quantity control valve (metering unit), which driving current influences the opening of the valve and, consequently, the volumetric flow rate, is normally output as a controlled variable. Using, in general, a linear relationship, this driving current is determined from a setpoint volumetric flow rate that is output by the controller. However, in addition, it has been recognized, according to the present invention, that the volumetric flow rate is also a marked function of the supply pressure in the so-called low-pressure region in front of the high-pressure pump. This supply pressure is mainly generated by a presupply pump, e.g., an electric fuel pump (EFP). Therefore, a determination of the driving current using only the setpoint volumetric flow rate is not optimal. The quality of the rail pressure control may be improved considerably, when the supply pressure is considered as well.

In the cases in which the EFP is directly connected to the vehicle electrical system, and/or in which a so-called ESM (energy smart management) is used, the quality of the pressure control is substantially influenced by the electrical system voltage. For in the event of fluctuations in the electrical system voltage, the supply pressure (low pressure), which is generated by the EFP, also fluctuates in these cases, so that as a result, the volumetric flow rate corresponding to a particular valve opening and, consequently, also the pressure in the high-pressure reservoir itself, fluctuate, which means that constant control action is necessary. To reduce this fluctuation, the present invention provides that the supply pressure also be considered in the pressure control. The design approach of the present invention minimizes the pressure fluctuations in the high-pressure reservoir, which are caused by fluctuations in the supply pressure. As a result, the fuel consumption may be decreased and an environmental impact may be reduced.

The supply pressure may be taken into account, in particular, in the control, in that, in particular, in a precontrol, it is taken into account additively or multiplicatively with respect to a precontrol value. A precontrol, per se, is known in rail pressure control and, in this case, is normally calibrated on the basis of rolling test stand measurements. In this context, normally, the actuating variable, e.g., the driving current for the quantity control valve, is acted upon, e.g., additively, by a calculated precontrol value in accordance with a mathematical rule. Since the precontrol assumes a considerable part of the control, the consideration of the supply pressure at this point produces special advantages. For then, during operation, only more small deviations of the pressure have to be compensated for by the controller, e.g., a PI controller.

Equally advantageously, the supply pressure may also be considered in the determination of the driving current from the setpoint volumetric flow rate, e.g., by correspondingly shifting a characteristics map.

The supply pressure may, for example, be measured or determined in a different manner. The supply pressure is determined in a particularly advantageous manner, using a voltage applied to the presupply pump. This may also be accomplished particularly advantageously in a vehicle-specific manner, by determining vehicle-specifically the relationship between the voltage applied to the presupply pump and the supply pressure.

A processing unit according to the present invention, e.g., a control unit of a motor vehicle, is configured to execute a method of the present invention, in particular, using software.

The implementation of the method in the form of software is also advantageous, since this generates particularly low costs, in particular, when an executing control unit is used for other tasks and is therefore already present. Suitable data carriers for making the computer program available include, in particular, diskettes, hard disks, flash memories, EEPROM's, CD-ROM's, DVD's, inter alia. A download of a program via computer networks (Internet, intranet, etc.) is also possible.

It is understood that the features mentioned above and the features yet to be described below may be used not only in the combination given in each case but also in other combinations or individually, without departing from the scope of the present invention.

The present invention is represented schematically in the drawing in light of exemplary embodiments and is described in detail below with reference to the drawings.

### BRIEF DESCRIPTION OF THE DRAWINGS

FIG. 1 schematically shows a common-rail fuel injection system, in light of which a preferred embodiment of a method according to the present invention is described.

FIG. 2 shows, with the aid of a control structure, a first preferred, specific embodiment of a method of the present invention.

FIG. 3 shows, with the aid of a further control structure, a second preferred, specific embodiment of a method of the present invention.

FIG. 4 shows, with the aid of a further control structure, a third preferred, specific embodiment of a method of the present invention.

### DETAILED DESCRIPTION

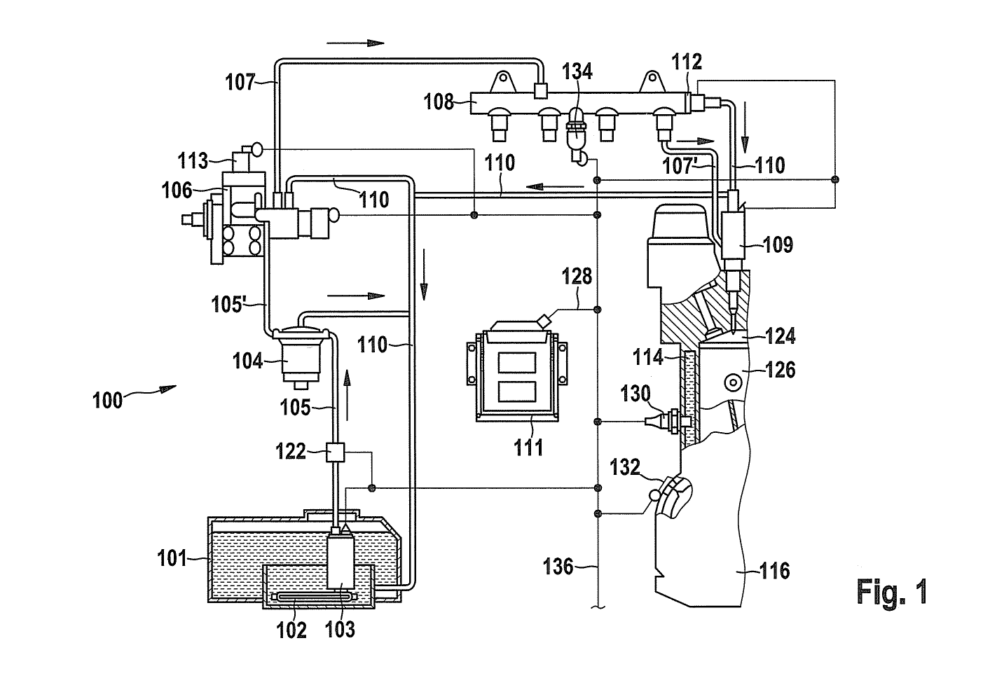

FIG. 1 schematically shows a common-rail fuel injection system 100 for an internal combustion engine 116, for example, a diesel engine. A piston 126 is movably positioned in a cylinder 124 of internal combustion engine 116, the cylinder being shown in a partial sectional view and being cooled by coolant 114. An injector 109 for injecting fuel into the cylinder is mounted at cylinder 124.

The fuel injection system includes a fuel tank 101, which is shown in a nearly filled state. A presupply pump 103 taking, in this case, the form of an electric fuel pump (EFP), which draws in fuel out of tank 101, through a preliminary filter 102, and transports it at a low pressure of 1 bar to, at most, 10 bar, through a fuel line 105, up to a fuel filter 104, is situated inside of fuel tank 101. A further low-pressure line 105′ leads from fuel filter 104 to a high-pressure pump 106, which compresses the supplied fuel to a high pressure that typically lies between 100 bar and 2000 bar, depending on the system. High-pressure pump 106 feeds the compressed fuel into a high-pressure line 107 and a rail 108 (high-pressure reservoir) connected to it. A further high-pressure line 107′ leads from rail 108 to injector 109. High-pressure pump 106 is equipped with a metering unit (MeUn) 113, which stipulates an amount of fuel that is delivered by high-pressure pump 106.

A system of return lines 110 allows excess fuel to flow out of fuel filter 104, high-pressure pump 106 or metering unit 113, injector 109 and rail 108, back into fuel tank 101. In this context, a pressure control valve (PCV) 112 is connected between rail 108 and return line 110, the pressure control valve being able to adjust the high pressure prevailing in rail 108 to a constant value by changing the amount of fuel flowing off from rail 108 into return line 110.

All of common-rail injection system 100 is controlled by a control unit 111, which is connected, via electric lines 128, to presupply pump 103, high-pressure pump 106, metering unit 113, injector 109, a pressure sensor 134 at rail 108, pressure control valve 112, as well as temperature sensors 130, 132, 122 at combustion engine 116 and at fuel intake line 105. The control unit is connected, via a bus system 136, to further control units not shown, by means of which it may access further data, such as the ambient temperature, the traveling speed or the engine speed.

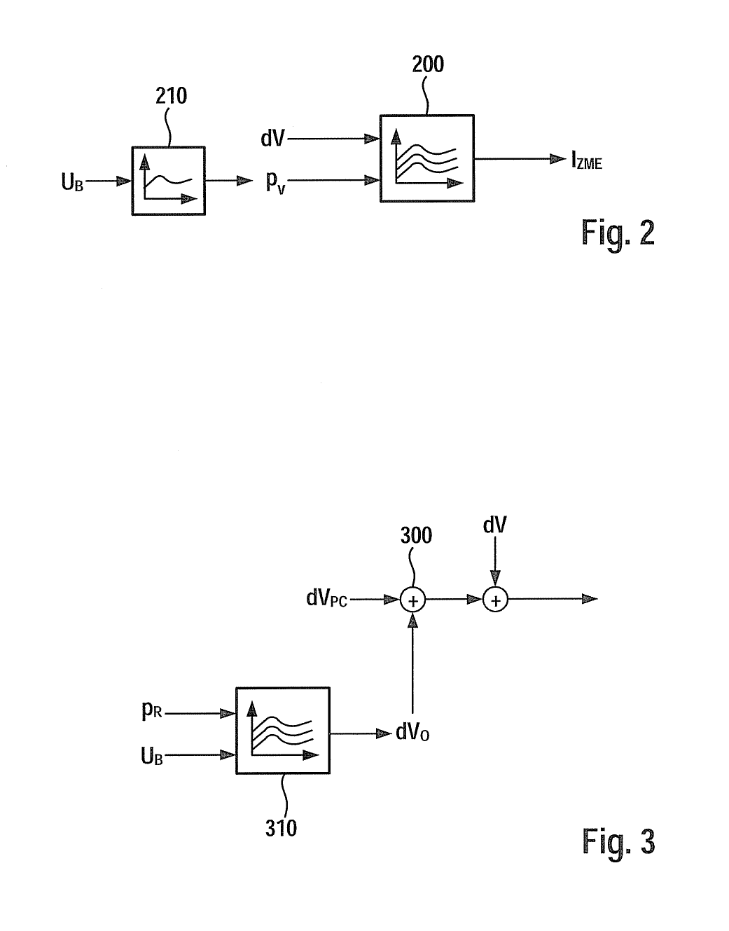

In FIG. 2, a first preferred, specific embodiment of the present invention is represented with the aid of a control loop diagram. In the case of the rail pressure control, the related art generally provides for a setpoint volumetric flow rate of fuel dV into the rail to be output by the controller and, subsequently, to be converted into a metering-unit driving current I_{MeUn}, using a linear relationship. According to the specific embodiment of the present invention represented here, this linear relationship is replaced by a relationship, in which supply pressure pᵥ is also considered. This relationship is schematically denoted by a block 200. Mathematical relationship 200 distinguishes itself, in particular, in that the driving current I_{MeUn} calculated for a particular volumetric flow rate dV is also a function of prevailing supply pressure pᵥ.

According to the specific embodiment of the invention represented in FIG. 1, supply pressure pᵥ is determined with the aid of electrical system voltage U_{B} in the motor vehicle. The determination is carried out with the aid of a relationship, which is represented by a block 210. Block 210 may advantageously be configured to be vehicle-specific, which means that in each instance, the vehicle-specific relationship between electrical system voltage U_{B} and supply pressure pᵥ is stored in the control.

The relationship between desired volumetric flow rate, prevailing supply pressure and resulting driving current may be determined, in particular, with the aid of test stand measurements.

In FIG. 3, a further preferred, specific embodiment of the present invention is represented with the aid of a further control loop diagram. According to this specific embodiment of the present invention, supply pressure pᵥ is considered in a precontrol. In this precontrol, volumetric flow rate dV is normally precontrolled. For example, as shown in FIG. 2, this precontrolled volumetric flow rate dV may be subsequently processed and converted into a driving current I_{MeUn}, preferably taking into account supply pressure pᵥ. The consideration of supply pressure pᵥ in the precontrol is preferably based on a known precontrol, as is used, for example, by the applicant. In such a customary precontrol, a precontrol value dV_{PC} for volumetric flow rate dV into the rail is determined with the aid of particular system variables, such as an engine speed and an injection amount. In this manner, the amount of fuel in the high-pressure reservoir lost due to an injection may be subsequently delivered almost in real time.

In an advantageous refinement of the present invention, it is now provided that an offset volumetric flow rate dV_{O} be added to this precontrol value dV_{PC} by an adder 300. Offset volumetric flow rate dV_{O} is determined, in turn, by a mathematical relationship of, expediently, setpoint rail pressure p_{R} and electrical system voltage U_{B}, the mathematical relationship being represented by a block 210.

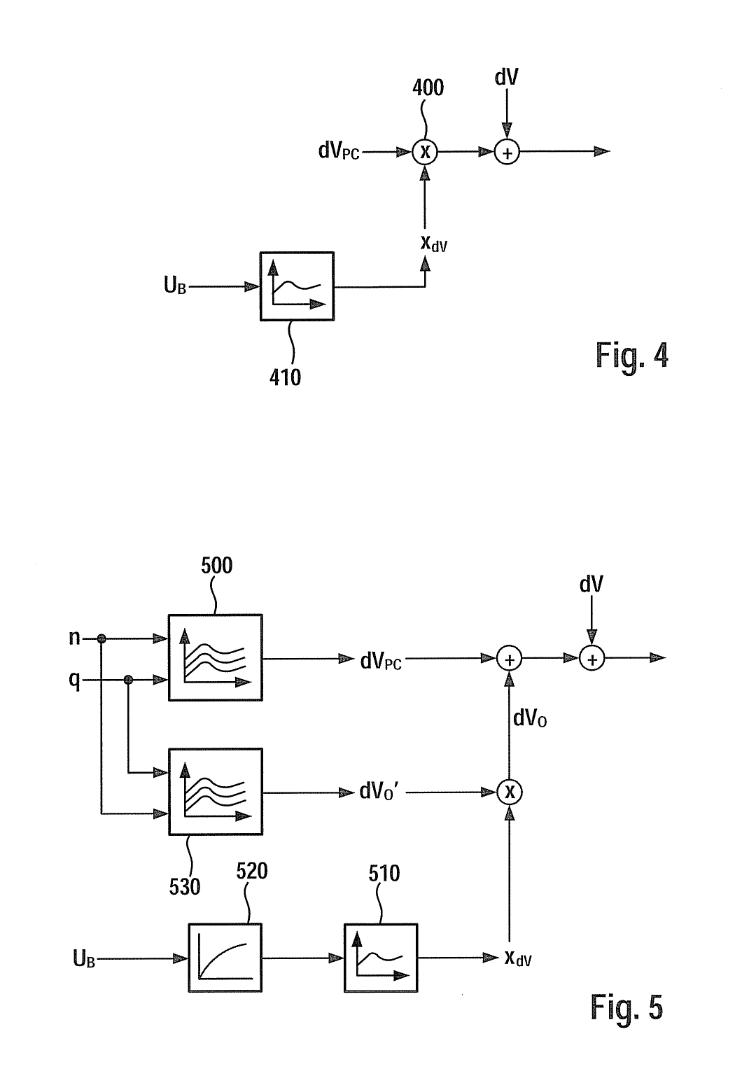

In the case of the precontrol, a further advantageous option for considering the supply pressure in view of the electrical system voltage is represented in FIG. 4 with the aid of a further control loop diagram. The control loop diagram according to FIG. 4 generally corresponds to the control loop diagram of FIG. 3, but volumetric flow rate precontrol value dV_{PC} is multiplied by a correction factor x_{dV}, using an element 400.

Factor x_{dV} is preferably determined from electrical system voltage U_{B} with the aid of a mathematical relationship represented by a block 410. Factor x_{dV} is, advantageously, about 1 at a normal electrical system voltage, increases with decreasing electrical system voltage, and decreases with increasing electrical system voltage. For example, factor x_{dV} may vary between 0.8 at a maximum electrical system voltage and 1.2 at a minimum electrical system voltage.

In FIG. 5, a further preferred, specific embodiment of the present invention is represented with the aid of a control loop diagram, the setpoint volumetric flow rate dV output by the controller being precontrolled. As also in the case of the specific embodiments according to FIGS. 3 and 4, the precontrol is executed using a precontrol value dV_{PC}, which is changed as a function of the supply pressure in accordance with the specific embodiment of the present invention represented here.

As implemented by the applicant, precontrol value dV_{PC} is determined on the basis of a relationship 500 of, inter alia, an injection amount q and an engine speed n. In a preferred, specific embodiment, a product dV_{O} of an offset volumetric flow rate dV_{O}′ and a correction factor x_{dV} is added to precontrol value dV_{PC .}

Offset volumetric flow rate dV_{O} is determined on the basis of a relationship 530 of, preferably, engine speed n and injection amount q.

Correction factor x_{dV} is determined with the aid of a relationship 510 of battery voltage U_{B}, which, as shown here, is preferably smoothed using a PTI filter 520; and therefore, the correction factor is also determined as a function of supply pressure pᵥ. For as described above, supply pressure pᵥ is a function of electrical system voltage U_{B}.

The mathematical relationships represented in FIGS. 2 through 5 may be, in particular, relationships representable by formulas or equations, or also characteristics maps that may be determined, e.g., by measurements.

The quality of the rail pressure control may be increased by the present invention, when the supply pressure in front of the high-pressure pump is a function of, e.g., the electrical system voltage.

What is claimed is:

1. A method for controlling a pressure in a high-pressure fuel reservoir of an internal combustion engine, comprising:
supplying fuel from a presupply pump to a quantity control valve;
transporting fuel metered by the quantity control valve by a high-pressure pump into the high-pressure fuel reservoir; and
controlling a pressure in the high-pressure fuel reservoir by controlling the quantity control valve, a supply pressure in front of the high-pressure pump being considered in the control.

2. The method according to claim 1, wherein the supply pressure is determined on the basis of a voltage applied to an electric fuel pump which is a presupply pump.

3. The method according to claim 2, wherein a relationship between the voltage applied to the electric fuel pump and the supply pressure provided by the electric fuel pump is considered in a vehicle-specific manner.

4. The method according to claim 1, wherein the supply pressure is considered in a precontrol.

5. The method according to claim 4, wherein a calculated precontrol value is at least one of (a) multiplied by a first value that is a function of the supply pressure and (b) added to a second value that is a function of the supply pressure.

6. The method according to claim 5, wherein the second value that is a function of the supply pressure is determined as a function of at least one of an engine speed and an injection amount.

7. The method according to claim 6, wherein the second value that is a function of the supply pressure is determined as a product of a third value, which is determined as a function of the engine speed and the injection amount, and a fourth value, which is determined as a function of the supply pressure.

8. The method according to claim 1, wherein the pressure in the high-pressure fuel reservoir is controlled by energizing the quantity control valve in a controlled manner, using a valve driving current.

9. The method according to claim 8, wherein the valve driving current is determined from a setpoint volumetric flow rate, and the supply pressure is considered in the determination.

10. A processing unit for controlling a pressure in a high-pressure fuel reservoir of an internal combustion engine, comprising:
means for supplying fuel from a presupply pump to a quantity control valve;
means for transporting fuel metered by the quantity control valve by a high-pressure pump into the high-pressure fuel reservoir; and
means for controlling a pressure in the high-pressure fuel reservoir by controlling the quantity control valve, a supply pressure in front of the high-pressure pump being considered in the control.
